(19) United States
(12) Patent Application Publication
(10) Pub. No.: US 2008/0185318 A1
(43) Pub. Date: Aug. 7, 2008

(54) Apparatus for Classifying Charge Material

(76) Inventors: Ludwig Konning, Ahlen (DE); Egbert Burchardt, Everswinkel (DE); Olaf Hagemeier, Beckum (DE); Franz-Josef Zurhove, Bad Iburg (DE)

Correspondence Address: STITES & HARBISON PLLC, 1199 NORTH FAIRFAX STREET, SUITE 900, ALEXANDRIA, VA, 22314, US

(21) Appl. No.: 12/064,741

(22) PCT Filed: Aug. 25, 2006
(86) PCT No.: PCT/EP2006/008363

§ 371 Date: Feb. 25, 2008

(30) Foreign Application Priority Data
Sep. 23, 2005 (DE) 10 2005 045 591.3

(51) Int. Cl. B07B 4/08; B07B 9/02

(52) U.S. Cl. 209/473; 209/483

(57) ABSTRACT

The invention relates to an apparatus for classifying charge material, comprising a static classifier which has a ventilating base oriented obliquely to the vertical and traversed by classifying gas; an inlet opening for charging the charge material to the ventilating base; an outlet opening for the coarse material; a downstream dynamic classifier which comprises at least one rotor; and at least one outlet opening for the classifying gas laden with fine material. The ventilating base has a ratio of width to vertical height of at least 0.45, preferably of at least 0.6.

The invention relates to a device for sifting charge material, having a static sifter, which has an aerating base oriented at an angle relative to the vertical and through which sifting gas passes, and a dynamic sifter arranged downstream.

A sifter for sifting granular material is known from DE 42 23 762, which sifter has a bar-cage sifter and, upstream thereof, a cascade sifter in shaft form. The cascade sifter has two opposite shaft-delimiting walls which are inclined relative to the vertical and form between them a preliminary sifting zone, and which are permeable to the sifting air. The shaft-delimiting walls are formed by sloping slatted guide plates through which sifting air flows transversely. The cascade sifter is operated in a closed circuit with a material bed roller mill, the guide plates serving to disagglomerate, i.e. to break up, the scabs formed in the material bed roller mill. The charge material is fed to the cascade sifter from the top and falls downwards over the guide plates, which are arranged stepwise, and is thereby disagglomerated and sifted. The fine constituents are fed to the bar-cage sifter together with the sifting air, while the coarse constituents are discharged at the bottom.

The size of the feed members to the sifter is dependent on the streams of material to be handled and yields compact, narrow mass flows compared with the sifter. The demands of high sifting efficiency require on the one hand that the charge amount per sifter width is limited and on the other hand that the cascade has a sufficient number of sifter stages connected in sequence—from the direction of material flow. Further fundamental parameters affecting the sifting efficiency are the uniformity of the width distribution of sifting material and sifting air. That uniformity is more difficult to achieve in wider sifters, for which reason the number of sifting stages increases with size. In sifters for small charge amounts, the width/height ratio is therefore approximately 0.15 and increases to about 0.35 in the case of larger amounts. These tall and narrow structural shapes result in high costs for the transportation of materials and for the buildings.

In DE 103 50 518, therefore, there is proposed, in the case of high throughputs, a sifting device for sifting granular material which comprises a static cascade sifter having at least one sifting zone which is enclosed by the shaft-like sifting housing and is arranged obliquely at an angle differing from the vertical, and a dynamic bar-cage sifter. The particular feature is that the sifting gas inlet housing of the sifting device, when viewed from the top, exhibits flow branching to two legs in the manner of a forked pipe, a floating bar cage being arranged in both forked pipe housing branches. The end bar-cage discharge ends, which are arranged as a mirror image opposite one another, are brought together by way of a further housing part to form a common discharge housing for the discharge of the sifting gas stream laden with fine material. According to a first variant, a static cascade sifter is arranged in each of the two forked pipe housing branches. In a second variant, a common cascade sifter is provided upstream of the branched portion.

The embodiment having two separate cascade sifters and two separate bar-cage sifters leads to relatively high costs. However, the variant having a common cascade sifter is also relatively expensive, because the cascade sifter requires a very high installation height in the case of a high throughput owing to its disadvantageous width/height ratio.

The object underlying the invention is, therefore, substantially to reduce the installation height of the sifting device having a static and a dynamic sifter and to improve the sifting efficiency in the case of sifters having different throughputs.

That object is achieved according to the invention by the features of claim 1.

The device according to the invention for sifting charge material consists essentially of a static sifter, which has an aerating base oriented at an angle relative to the vertical and through which sifting gas flows, an inlet opening for delivering the charge material to the aerating base, an outlet opening for the coarse material, a dynamic sifter, located downstream, which comprises at least one rotor, and an outlet opening for the sifting gas laden with fine material. The aerating base has a width to vertical height ratio of at least 0.45, preferably of at least 0.6.

Further developments of the invention are the subject of the dependent claims.

According to a preferred embodiment, a device for distributing the charge material over the width of the aerating base is also provided. Furthermore, disagglomerating means are advantageously arranged upstream of the static sifter.

According to a preferred embodiment, the surface of the aerating base is planar and is provided with aerating openings, in particular aerating slots. The aerating base is arranged at an angle of from 20° to 70°, preferably from 30° to 60°, relative to the vertical.

According to a preferred embodiment of the invention, the aerating bases of the devices within a line for different throughputs differ from one another only in terms of their width and not in terms of their vertical height. In addition to the already substantially more advantageous width to vertical height ratio, this also means that the installation height does not increase when the device has to be designed with a higher throughput.

Further advantages and developments of the invention are explained in greater detail hereinbelow by means of the description of some exemplary embodiments and the drawings.

In the drawings

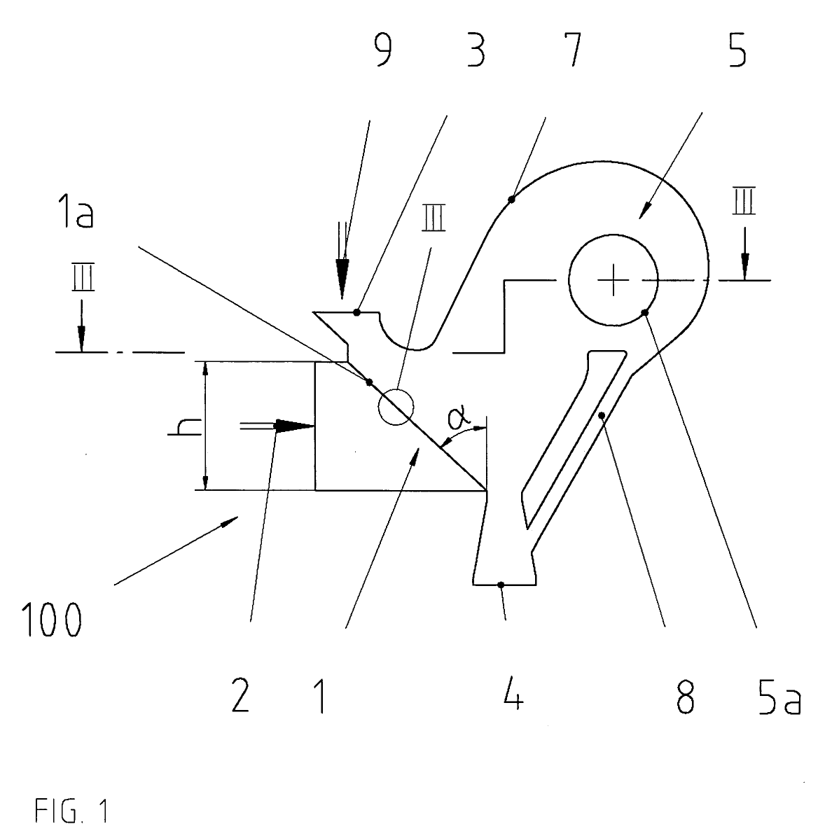

FIG. 1 shows a side view, in diagrammatic form, of the sifting device,

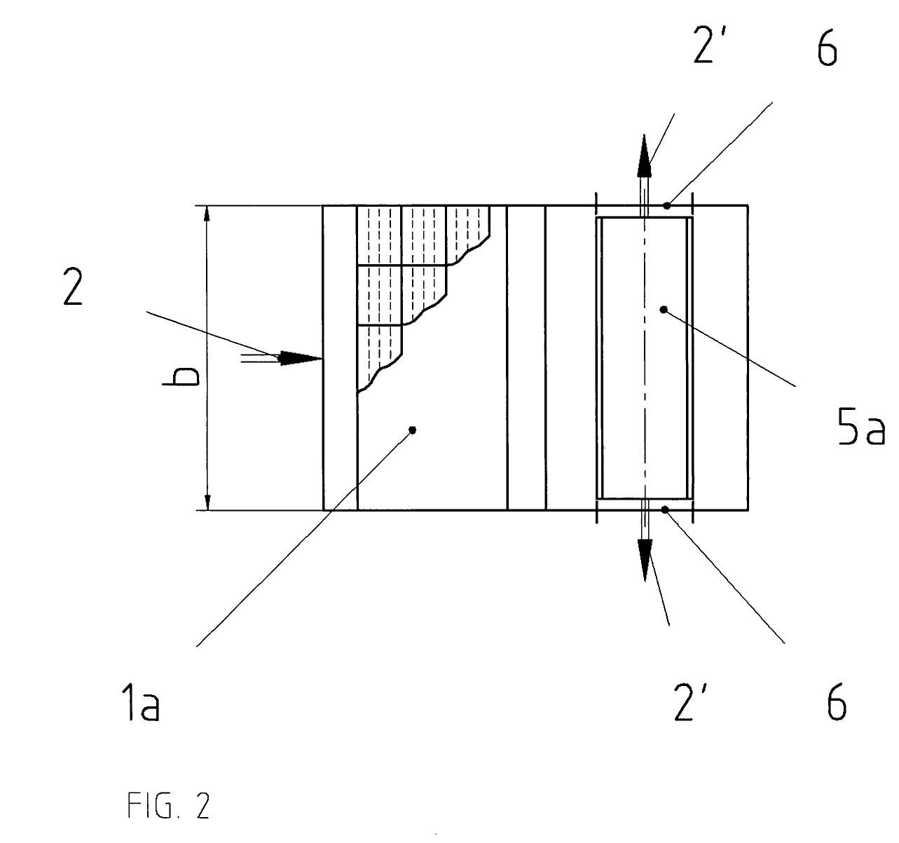

FIG. 2 shows a sectional view, in diagrammatic form, along line III-III of FIG. 1,

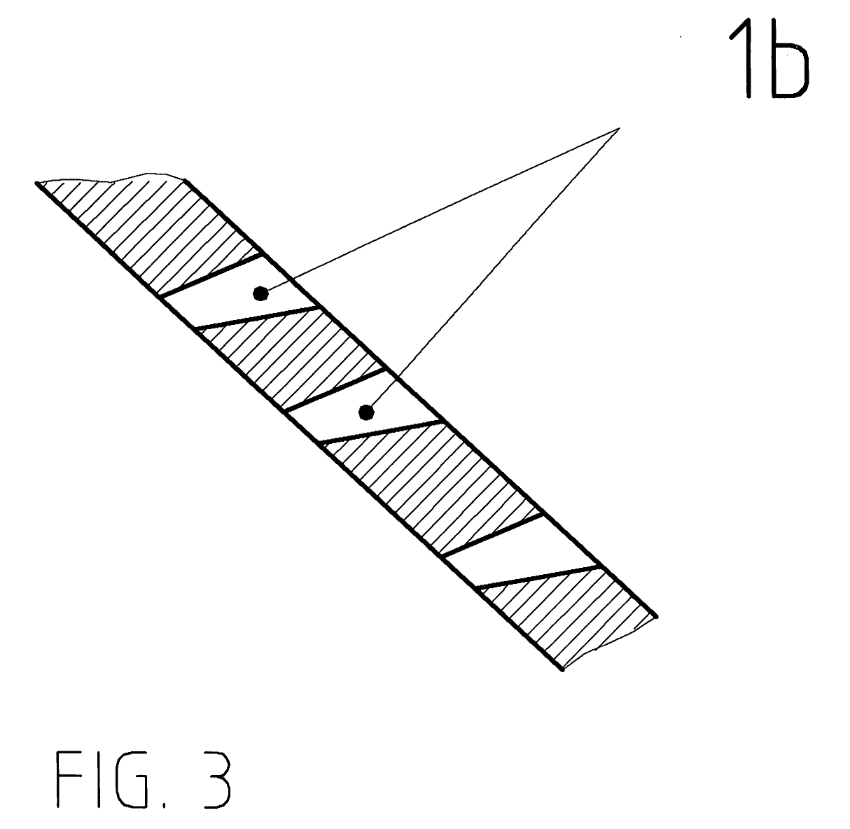

FIG. 3 shows a sectional view of detail III of FIG. 1,

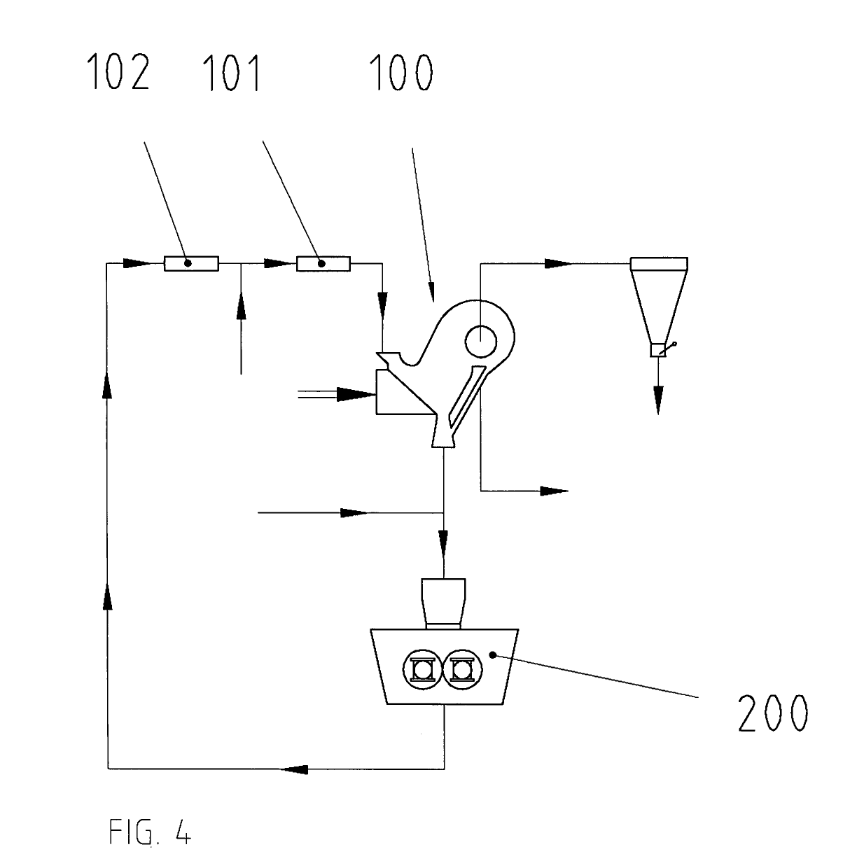

FIG. 4 shows a flow diagram of a milling installation having a sifting device according to the invention,

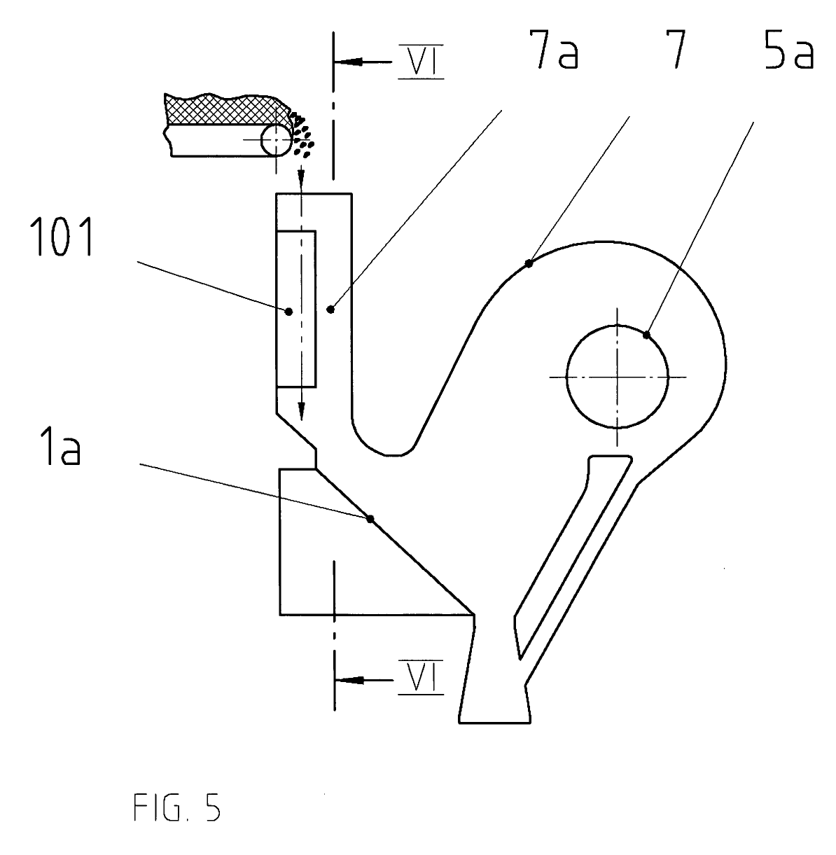

FIG. 5 shows a side view of a sifting device having a distributing device according to a first exemplary embodiment,

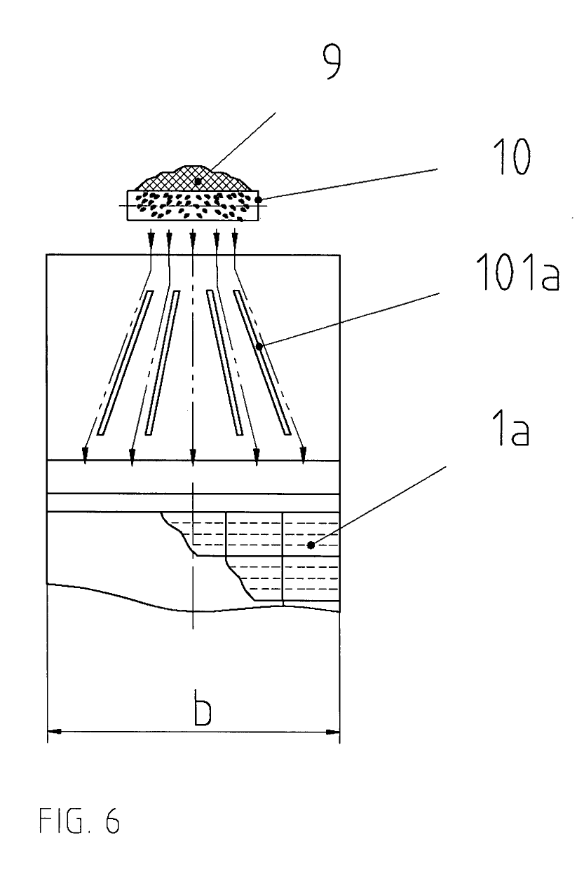

FIG. 6 shows a sectional view, in diagrammatic form, along line VI-VI of FIG. 5,

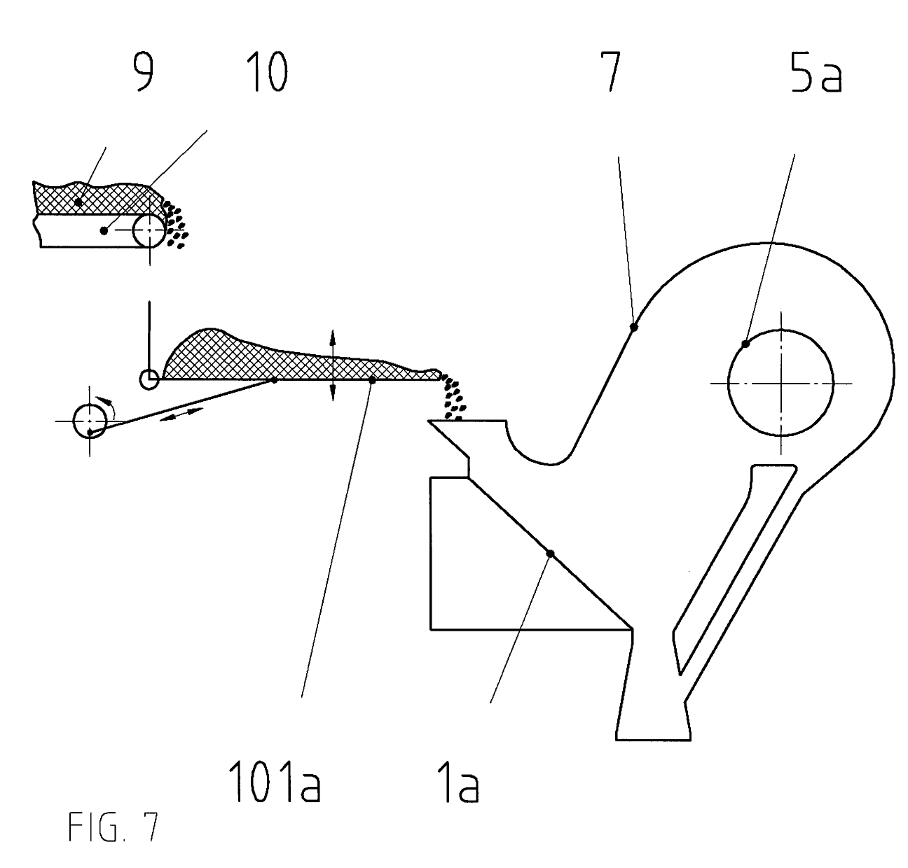

FIG. 7 shows a side view, in diagrammatic form, of a sifting device having a distributing device according to a second exemplary embodiment,

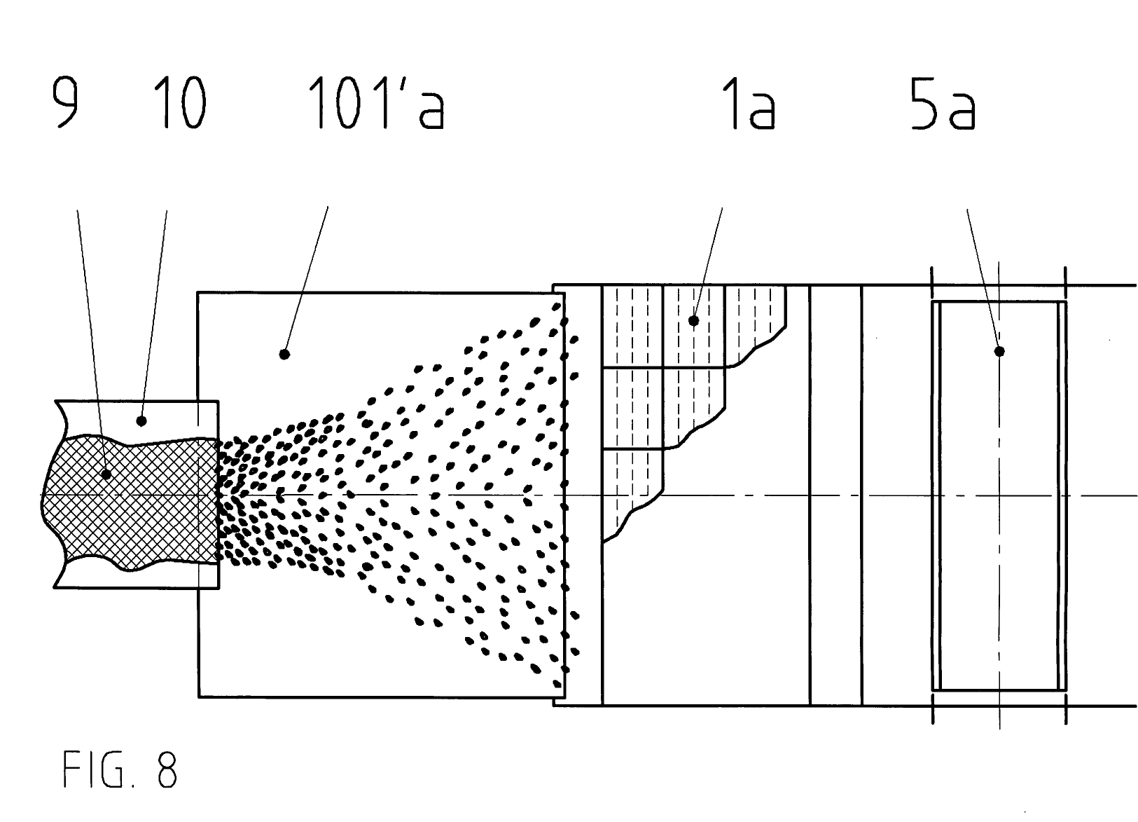

FIG. 8 shows a partially cutaway top view, in diagrammatic form, of FIG. 7,

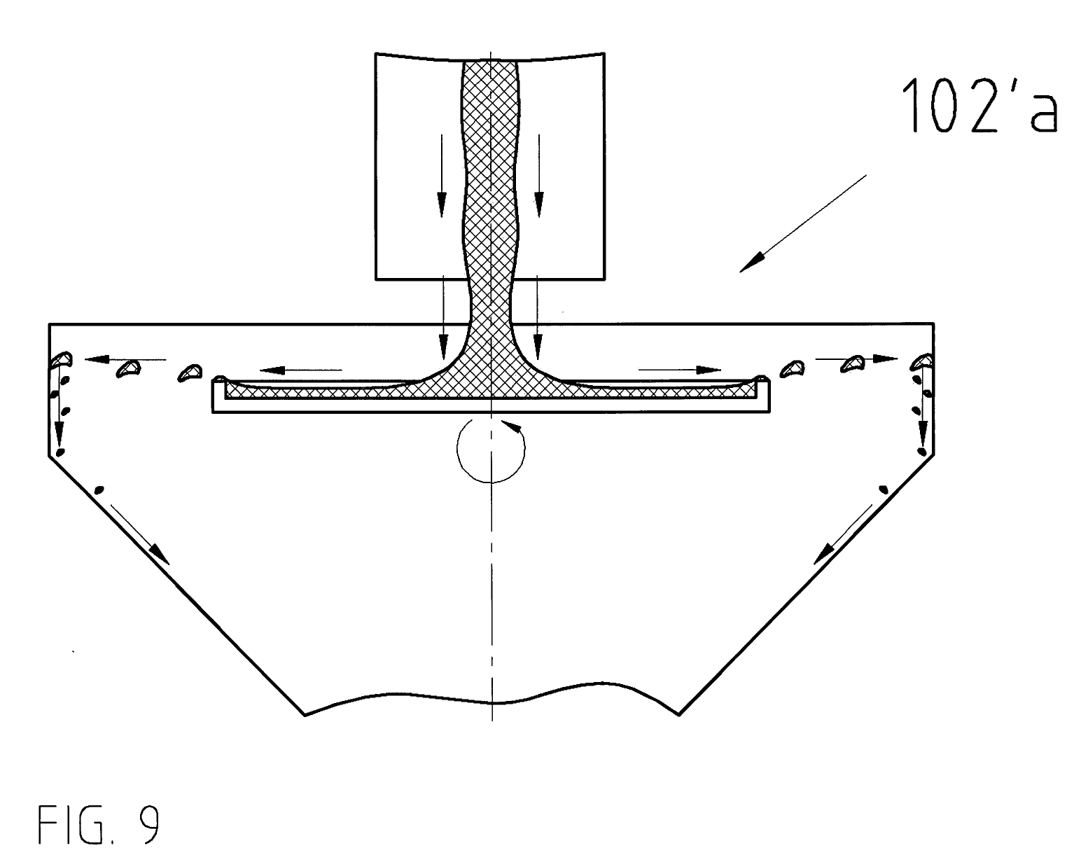

FIG. 9 shows a view, in diagrammatic form, of disagglomerating means according to a first exemplary embodiment, and

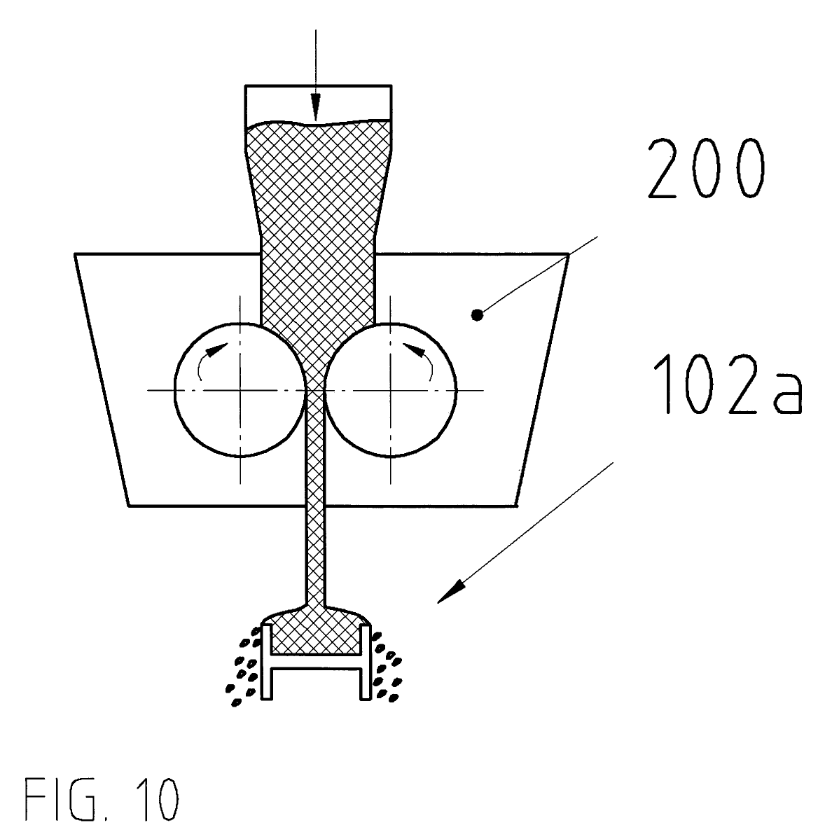

FIG. 10 shows a view, in diagrammatic form, of disagglomerating means according to a second exemplary embodiment.

The device 100 shown in FIG. 1 to FIG. 3 for sifting charge material consists essentially of a static sifter 1, which has an aerating base 1a oriented at an angle relative to the vertical and through which sifting gas 2 flows, an inlet opening 3 for delivering the charge material 9 to the aerating base, an outlet opening 4 for the coarse material, a dynamic sifter 5, located downstream, which comprises at least one rotor 5a, and at least one outlet opening 6 for the sifting gas 2′ laden with fine material.

The aerating base 1a is arranged at an angle α of from 20° to 70°, preferably from 30° to 60°, relative to the vertical. In the exemplary embodiment shown, the surface of the aerating base 1a is planar and is provided with aerating openings 1b, in particular aerating slots (see FIG. 3).

The aerating base 1a has a width b to vertical height h ratio of at least 0.45, preferably of at least 0.6. Accordingly, the width of the aerating base is substantially greater than in known designs of equivalent performance and therefore makes a substantial contribution towards reducing the installation height of the sifting device. (Note: In the case of b/h=0.6, the width is smaller than the height!).

The static sifter 1 and the dynamic sifter 5 are accommodated in a common housing 7, the dynamic sifter being arranged in the side view shown in FIG. 1 at an angle above the aerating base.

The charge material 9 supplied by way of the inlet opening 3 slides downwards over the aerating base 1a, and the sifting gas thereby passes transversely through it. The fine material of the charge material is carried with the sifting gas 2 to the dynamic sifter, which comprises one or more rotors, in particular bar cages.

The medium-grained fraction rejected in the region of the rotor is passed by way of a return 8 arranged inside the housing to the outlet opening 4 for the coarse material. The rotor is advantageously mounted on both sides and can correspond in terms of its width to the width of the aerating base. It would also be conceivable, however, for the width of the rotor to be greater or, especially, smaller than the width of the aerating base. In that case, there is provided between the static and dynamic sifters a housing transition portion, which connects together the housing regions of different widths of the housing 7 in the region of the static sifter or of the dynamic sifter.

FIG. 4 shows the sifting device 100 with a material bed roller mill 200. In addition to the actual sifter, the device 100 also comprises a device 101 for distributing the charge material over the width of the aerating base 1a, as well as means 102 for disagglomerating the material fed back from the material bed roller mill 200 to the sifting device.

FIG. 5 and FIG. 6 show a first exemplary embodiment of a device 101 for distributing the charge material over the width of the aerating base. In the exemplary embodiment shown, that device comprises guide plates which are arranged in the feed shaft 7a of the housing 7. The guide plates 101a are in such a form that they distribute the charge material 9, which is supplied in a specific width by feed means 10, over the width b of the aerating base 1a.

However, dynamic means are also conceivable instead of a static device for distributing the charge material. In FIG. 7 and FIG. 8, the device 101 is formed by a vibrating trough 101′a.

There comes into consideration for the disagglomerating means 102 located upstream a scab breaker 102a according to FIG. 10, for example, which is advantageously arranged beneath the material bed roller mill 200. Alternatively, however, a spinner 102′a according to FIG. 9, for example, would also be conceivable.

The mass flow of charge material on the aerating base 1a decreases from top to bottom, because more and more fine material is discharged with the sifting air during the residence time. As a result, the flow resistance of the charge material in the direction towards the outlet opening 4 for the coarse material decreases. In order that the sifting air can nevertheless flow uniformly through the charge material, the aerating base is in such a form that it produces a pressure drop of from 2 mbar to 8 mbar, preferably from 3 mbar to 4 mbar.

The above-described sifting device is distinguished by the fact that the aerating bases 1a of devices within a line for different throughputs differ from one another only in terms of their width b and not in terms of their vertical height h. This means that the device increases only in terms of its width, while the installation height remains substantially the same. This in turn means that the sifting efficiency is substantially the same for devices with different throughputs because, unlike conventional devices, the residence time, which is determined substantially by the vertical height, remains unchanged.

As the width increases, the device for distributing the charge material over the width of the aerating base becomes ever more important. Within the scope of a line, the width of the dynamic rotor is preferably changed linearly with the width of the static aerating base. The width of the rotor can in principle be different from the width of the static stage. In particular, the demands in finished milling and partially finished milling with partial finished material discharge in the production process are fundamentally different, so that fixed combinations of static and dynamic sifters of different widths can be used here. The sifting chambers of the static and dynamic stages are then optionally connected by way of transition portions.

The stronger the aeration of the aerating base 1a, the flatter it can be installed. Taking account of the conventional sifting air requirement and the material flow behaviour, an inclination of approximately 45°±10° will preferably be used. The air outlet rate from the aerating base is chosen to be such that most of the charge material remains suspended and only the coarse material comes into contact with the aerating base. This also prevents the material from blocking the aerating openings and causing depositions. In order to achieve this, air velocities at the outlet openings 1b of the aerating base of at least 20 m/s, preferably of 30 m/s, should be established.

The device according to the invention for sifting charge material is distinguished by high sifting efficiency and, compared with known cascade sifters, requires a substantially smaller installation height, resulting in a cost saving.

1. Static-dynamic sifter for sifting (100) charge material, having
a. a static sifter (1) which has an aerating base (1a) oriented at an angle relative to the vertical and through which sifting gas (2) flows,
b. an inlet opening (3) for delivering the charge material (9) to the aerating base (1a),
c. an outlet opening (4) for the coarse material,
d. a dynamic sifter (5), located downstream, which comprises at least one rotor (5a), and
e. at least one outlet opening (6) for the sifting gas 2′ laden with fine material, characterised in that
the aerating base (1a) has a width (b) to vertical height (h) ratio of at least 0.45, preferably of at least 0.6.

2. Static-dynamic sifter according to claim 1, characterised in that a device (101) for uniformly distributing the charge material over the width of the aerating base is also provided.

3. Static-dynamic sifter according to claim 1, characterised in that disagglomerating means (102) are arranged upstream of the static sifter.

4. Static-dynamic sifter according to claim 1, characterised in that the width of the rotor (5a) is different from the width of the aerating base (1a), and a housing transition portion is provided between the static and dynamic sifters.

5. Static-dynamic sifter according to claim 1, characterised in that the surface of the aerating base (1a) is planar and is provided with aerating openings (1b).

6. Static-dynamic sifter according to claim 1, characterised in that the aerating base (1a) is at an angle of from 20° to 70°, preferably from 30° to 60°, relative to the vertical.

7. Static-dynamic sitter according to claim 1, characterised in that the aerating base (1a) is in such a form that it produces a pressure drop of from 2 mbar to 8 mbar, preferably from 3 mbar to 4 mbar.

8. Static-dynamic sifter according to claim 1, characterised in that the aerating bases (1a) of devices within a line for different throughputs differ from one another only in terms of their width (b) and not in terms of their vertical height (h).

9. Milling installation having a static-dynamic sifter according to claim 1 as well as a material bed roller mill.
